(19) United States
(12) Patent Application Publication
(10) Pub. No.: US 2008/0005322 A1
(43) Pub. Date: Jan. 3, 2008

(54) Input/output processing device and computer system with the input/output processing device

(75) Inventor: Tetsuo Hatakeyama, Tachikawa-shi (JP)

Correspondence Address: BLAKELY SOKOLOFF TAYLOR & ZAFMAN, 1279 OAKMEAD PARKWAY, SUNNYVALE, CA, 94085-4040, US

(73) Assignee: Kabushiki Kaisha Toshiba

(21) Appl. No.: 11/807,646

(22) Filed: May 29, 2007

(30) Foreign Application Priority Data
May 31, 2006 (JP) 2006-152539

(51) Int. Cl. G06F 15/173

(52) U.S. Cl. 709/224

(57) ABSTRACT

According to one embodiment, an input/output processing device includes an input controller configured to sequentially input stream data including a plurality of successive packets each having a fixed length, the input controller inputting the stream data in units of data blocks each having a first length shorter than the fixed length, an output controller configured to sequentially output, to a bus, data blocks each having a second length different from the fixed length, a transfer buffer configured to accumulate data blocks input by the input controller while data blocks are output to the bus by the output controller, and a transfer-buffer input controller configured to eliminate overflow, when the overflow occurs in the transfer buffer, by at least temporarily interrupting a data input operation of the input controller, and to cause the input controller to resume the data input operation with at least one of the packets lost.

### CROSS-REFERENCE TO RELATED APPLICATIONS

This application is based upon and claims the benefit of priority from Japanese Patent Application No. 2006-152539, filed May 31, 2006, the entire contents of which are incorporated herein by reference.

### BACKGROUND

1. Field

One embodiment of the invention relates to an input/output processing device connected, to a host system via a bus operative in synchronism with a bus clock signal, for performing input/output processing between an input/output device and the host system, and a computer system including the input/output processing device.

2. Description of the Related Art

In general, a computer system represented by a personal computer includes a bus such as a peripheral component interconnect (PCI) bus, which operates in synchronism with a bus clock signal. The bus is connected to a host system that utilizes various input/output (I/O) devices, and also to an input/output (I/O) processing device. The I/O processing device operates in synchronism with the bus clock signal to perform input/output processing between the I/O device and host system.

Some I/O processing devices perform I/O processing during packet stream data transfer. This type of I/O processing device generally inputs stream data formed of a series of packets, accumulates it in a transfer buffer as data blocks each having a length different from the length of a packet, and outputs the accumulated data to a bus.

When a delay occurs during processing on the bus, a sufficient output processing rate for an input processing rate cannot be acquired in the transfer buffer, which causes overflow. In this case, unless appropriate countermeasures are taken, a defective packet, in which part of data therein is missing, may be output to the bus, thereby causing an error in the host system.

Various countermeasures to be taken when overflow occurs in a buffer have been proposed so far. For instance, Jpn. Pat. Appln. KOKAI Publication No. 2004-320151 discloses a technique for discarding a defective frame that occurs when overflow has occurred in a buffer and data in a packet included in the frame has been lost, thereby preventing occurrence of such a defective frame.

In this technique, although occurrence of defective frames can be avoided, any defective frame, which still contains normal packets, is discarded. Namely, even normal packets are discarded. Further, a frame-receiving side must discard the already received part of a defective frame.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram illustrating an exemplary configuration of a computer system according to an embodiment of the invention;

FIG. 2 is an exemplary conceptual diagram useful in explaining a basic operation example of the I/O processing device appearing in FIG. 1;

FIG. 3 is an exemplary conceptual diagram useful in explaining data accumulated in a preset memory area formed in the system memory appearing in FIG. 1;

FIGS. 4A, 4B and 4C are exemplary conceptual diagrams useful in explaining three states 1 to 3 assumed, upon occurrence of overflow, in the transfer buffer appearing in FIG. 1;

FIGS. 5A, 5B and 5C are exemplary conceptual diagrams useful in explaining data stored in the memory area of the system memory, appearing in FIG. 1, in accordance with the states shown in FIGS. 4A, 4B and 4C;

FIG. 6 is an exemplary timing chart illustrating an operation example corresponding to state 2 shown in FIG. 4B; and

FIG. 7 is an exemplary timing chart illustrating an operation example corresponding to state 3 shown in FIG. 4C.

### DETAILED DESCRIPTION

Various embodiments according to the invention will be described hereinafter with reference to the accompanying drawings. In general, according to one embodiment of the invention, an input/output processing device includes an input controller configured to sequentially input stream data including a plurality of successive packets each having a fixed length, the input controller inputting the stream data in units of data blocks each having a first length shorter than the fixed length, an output controller configured to sequentially output, to a bus, data blocks each having a second length different from the fixed length, a transfer buffer configured to accumulate data blocks input by the input controller while data blocks are output to the bus by the output controller, and a transfer-buffer input controller configured to eliminate overflow, when the overflow occurs in the transfer buffer, by at least temporarily interrupting a data input operation of the input controller, and to cause the input controller to resume the data input operation with at least one of the packets lost.

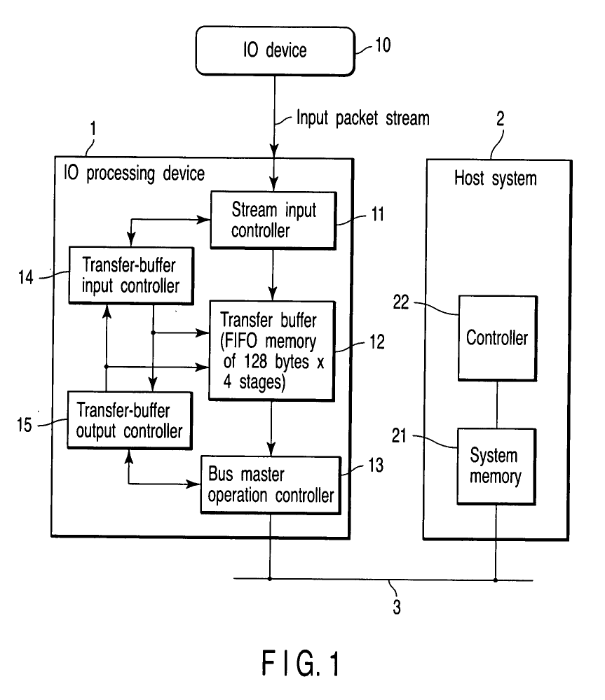

FIG. 1 is a block diagram illustrating an exemplary configuration of a computer system according to the embodiment.

The computer system of FIG. 1 is, for example, a personal computer, and includes an input/output processing device (hereinafter referred to as “the I/O processing device”) 1, host system 2, bus 3, input/output device (hereinafter referred to as “the I/O device”) 10, etc. The I/O processing device 1 is connected between the I/O device 10 and bus 3. The host system 2 is connected to the I/O processing device 1 via the bus 3. The bus 3 is, for example, a PCI bus.

The I/O device 10 includes a stream input controller 11, transfer buffer 12, bus master operation controller (data output controller) 13, transfer-buffer input controller 14 and transfer-buffer output controller 15. The host system 2 includes a system memory 21 and controller 22.

The I/O processing device 1 performs I/O processing during packet stream data transfer, and is realized as hardware. The I/O processing device 1 receives, from the I/O device 10, data in the form of a packet stream, and transfers it to the system memory 21 of the host system 2 connected to the device 1 via the bus 3. The packet stream input to the I/O processing device 1 is formed of a series of fixed-length packets each having a packet size corresponding to a fixed length of 192 bytes, and is a byte stream that can be transferred in units of bytes.

The stream input controller 11 sequentially inputs stream data in units of 16 bytes smaller than 192 bytes as the fixed length of each packet, and outputs it to the transfer buffer 12.

The transfer buffer 12 is a memory including a plurality of memory areas, and accumulates, in units of 128 bytes, the data input to the stream input controller 11 while data is output by the bus master operation controller 13 to the bus 3. The transfer buffer 12 is controlled by the transfer-buffer input controller 14 and transfer-buffer output controller 15 so that the buffer functions as a FIFO memory of 128 bytes×4 stages.

The bus master operation controller 13 sequentially inputs data of 128 bytes from the transfer buffer 12, and outputs, to the bus 3, data to be written to the system memory 21 of the host system 2.

The transfer-buffer input controller 14 controls the input operation of the transfer buffer 12 to make the buffer serve as a FIFO memory, and performs control upon occurrence of overflow. The transfer-buffer input controller 14 can recognize the data in the transfer buffer 12, utilizing information for controlling the stream input controller 11 or transfer buffer 12, or information acquired from the transfer-buffer output controller 15.

When overflow occurs in the transfer buffer 12, the transfer-buffer input controller 14 at least temporarily interrupts the data input operation of the stream input controller 11 to thereby eliminate the overflow, and resumes the input of data to the stream input controller 11 in the state in which data loss has occurred in units of packets (i.e., with at least one of the packets lost). In particular, when overflow has occurred after part of the data of a packet is input to the transfer buffer 12, the transfer-buffer input controller 14 temporarily interrupts the data input operation of the stream input controller 11, and discards at least the above-mentioned part of the data in the transfer buffer 12, thereby eliminating the overflow, and causing the stream input controller 11 to resume the data input operation beginning with a leading portion of a subsequent packet. At this time, the transfer-buffer input controller 14 performs the discarding operation in units of 128 bytes (i.e., in units of memory areas in the transfer buffer 12).

The transfer-buffer output controller 15 controls the output operation of the transfer buffer 12 to make the buffer serve as a FIFO memory. For instance, the transfer-buffer output controller 15 controls the transfer buffer 12 in accordance with the information acquired from the transfer-buffer input controller 14, controls the bus master operation controller 13, and supplies the transfer-buffer input controller 14 with information indicating data output.

On the other hand, the host system 2 receives data from the I/O processing device 1 via the bus 3, and processes it as packets each having the aforementioned length. The system memory 21 has a preset memory area (buffer) for processing, in units of 192 bytes, the data transferred from the I/O processing device 1 via the bus 3. The controller 22 processes, in units of 192 bytes, the data accumulated in the system memory 21, by executing the operating system and a preset application.

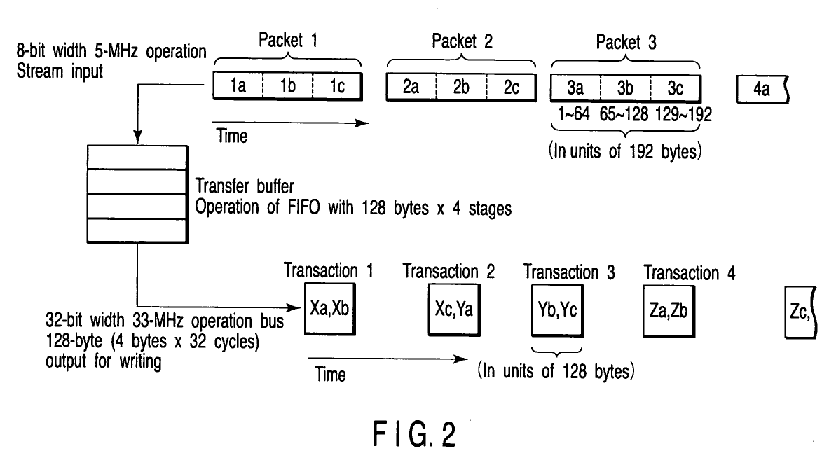

FIG. 2 is a conceptual diagram useful in explaining a basic operation example of the I/O processing device 1.

As described above, data input as a packet stream and output to the bus for writing is formed of packets having a fixed length of 192 bytes.

In FIG. 2, each packet having a fixed length of 192 bytes is divided into a, b and c sections, the a section being data of 64 bytes ranging from the 1st byte to the 64th byte, the b section being data of 64 bytes ranging from the 65th byte to the 128th byte, and the c section being data of 64 bytes ranging from the 129th byte to the 192nd byte.

The stream input controller 11 detects the leading portion of a packet at the start of processing, then inputs data in units of 16 bytes, and outputs the data to the transfer buffer 12 having input thereof controlled so that the buffer serves as a FIFO memory.

When data more than 128 bytes is accumulated in the transfer buffer 12, the bus master operation controller 13 performs, in units of 128 bytes, control for inputting data from the transfer buffer 12 having output thereof controlled by the transfer-buffer output controller 15 so that the buffer serves as a FIFO memory, then outputting the data to the bus 3 for writing after the use of the bus 3 is enabled, and transferring the data to the system memory 21. The output processing time of the bus master operation controller 13 for outputting 128-byte data after the use of the bus 3 is enabled is sufficiently earlier than the inputting processing time of the stream input controller 11 for inputting 128-byte data in total (this inputting process is performed in units of 16 bytes).

The time, for which the bus master operation controller 13 is kept standby until the use of the bus 3 is enabled, depends upon the state of the system. When the amount of data input to the transfer buffer 12 by the stream input controller 11 exceeds, temporarily per unit time, the amount of data output by the bus mater operation controller 13, the transfer buffer 12 can accumulate data of up to 512 bytes (128 bytes×4). When data of 512 bytes has been accumulated, and further data input occurs in the stream input controller 11, the transfer-buffer input controller 14 detects the overflow state of the transfer buffer 12, and the stream input controller 11 does not output, to the transfer buffer 12, the data input thereto in response to an instruction from the transfer-buffer input controller 14, and stops further input of data.

The overflow state is eliminated when the bus master operation controller 13 causes the transfer buffer 12 to output data to the bus 3, or when the transfer-buffer input controller 14 discards data contained in the transfer buffer 12, thereby producing in the transfer buffer 12 a free space for permitting new data to be input thereto. When a free space is produced in the transfer buffer 12, the transfer-buffer input controller 14 issues an instruction to the stream input controller 11, and the stream input controller 11, in turn, detects the leading portion of a packet included in input stream data, and then inputs the input data to the transfer buffer 12.

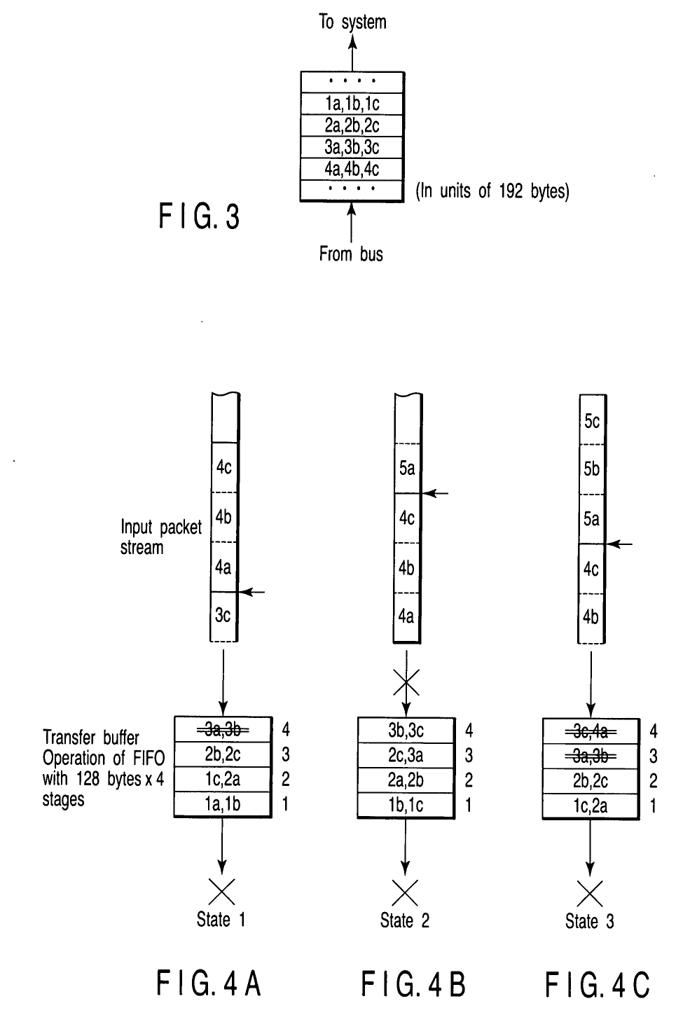

FIG. 3 is a conceptual diagram useful in explaining data accumulated in a preset memory area formed in the system memory 21. As shown in FIG. 3, data transferred in units of 128 bytes to the host system 2 via the bus 3 is sequentially stored in unit of 192 bytes (corresponding to the length of each packet) in the preset memory area of the system memory 21. The controller 22 processes the data stored in the system memory 21. If part of the data having a data length equal to the length of each packet is lost, it is possible that malfunction may occur during data processing.

FIGS. 4A, 4B and 4C are conceptual diagrams useful in explaining three states 1 to 3 assumed, upon occurrence of overflow, in the transfer buffer 12.

When overflow has occurred upon the input of the leading byte of a 192-byte (fixed-length) packet as shown in state 1 of FIG. 4A or state 3 of FIG. 4C, the data is discarded, which ranges from the data as the leading portion of 128-byte data (corresponding to the output transfer size), which serves as the leading portion of packet data, to the last input data included in the last packet input halfway to the transfer buffer 12. As a result, a free space is produced in the transfer buffer 12.

Specifically, when, as is shown in state 1 of FIG. 4A, overflow has occurred upon the input of the 129th byte of a 192-byte (fixed-length) packet, the leading data of which is formed of the first data of the data input in units of 128 bytes, the last (i.e., the fourth) 128-byte data “3a, 3b” included in the input data is discarded. As a result of this discarding process, a free space is produced to thereby eliminate the overflow, and the input operation is resumed beginning with the leading 128-byte data “4a, 4b” of the packet data subsequently detected.

When, as is shown in state 3 of FIG. 4C, overflow has occurred upon the input of the 65th byte of a 192-byte (fixed-length) packet, the leading data of which is formed of the first data of the data input in units of 128 bytes, the data ranging from the third 120-byte data “3a, 3b” to the fourth (last) 128-byte data “3c, 4a” is discarded. As a result of this discarding process, a free space is produced to thereby eliminate the overflow, and the input operation is resumed beginning with the leading 128-byte data “5a, 5b” of the packet data subsequently detected.

When, as shown in state 2 of FIG. 4B, overflow has occurred upon the input of the 1st byte of a 192-byte (fixed-length) packet, the data contained in the transfer buffer 12 is maintained as it is. After a free space is produced by the output operation of the bus master operation controller 13, the overflow is eliminated, and the input operation is resumed beginning with the leading 128-byte data of the packet data subsequently detected.

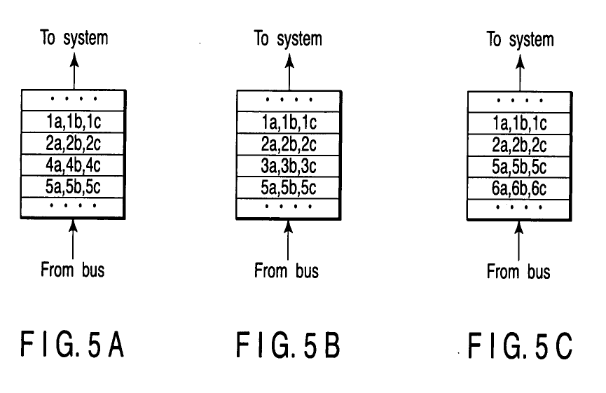

FIGS. 5A, 5B and 5C are conceptual diagrams useful in explaining data stored in the memory area of the system memory 21 in accordance with states 1 to 3 shown in FIGS. 4A, 4B and 4C.

In state 1 shown in FIG. 4A, the data “3a, 3b, 3c” corresponding to a 192-byte packet is discarded to eliminate overflow. In this case, data is stored and processed in the system memory 21 as a data transfer destination, with the data arrangement unchanged and the 192-byte (fixed-length) data “3a, 3b, 3c” eliminated, as is shown in FIG. 5A.

In state 2 shown in FIG. 4B, the data “4a, 4b, 4c” corresponding to a 192-byte packet is discarded to eliminate overflow. Also in this case, data is stored and processed in the system memory 21 as the data transfer destination, with the data arrangement unchanged and the 192-byte (fixed-length) data “4a, 4b, 4c” eliminated, as is shown in FIG. 5B.

Similarly, in state 3 shown in FIG. 4C, the data “4a, 4b, 4c” and “5a, 5b, 5c” corresponding to two 192-byte packets is discarded to eliminate overflow. In this case, data is stored and processed in the system memory 21 as the data transfer destination, with the data arrangement unchanged and the two 192-byte (fixed-length) data items “4a, 4b, 4c” and “5a, 5b, 5c” eliminated, as is shown in FIG. 5C.

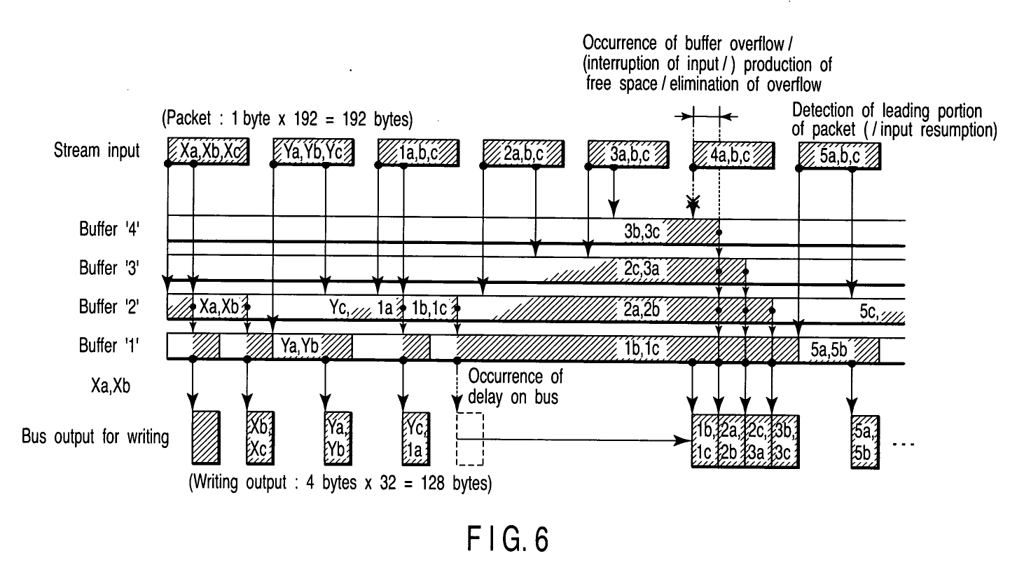

FIG. 6 is a timing chart illustrating an operation example corresponding to state 2 shown in FIG. 4B.

As shown in FIG. 6, since a delay has occurred during processing on the bus 3, buffers 1, 2, 3 and 4 are sequentially filled with data in this order. When overflow has occurred upon the input of the leading byte of the 192-byte (fixed-length) data “4a, 4b, 4c”, the data items “1b, 1c”, “2a, 2b”, “2c, 3a” and “3b, 3c” in the transfer buffer 12 are maintained as they are. After a free space is produced by the output operation of the bus master operation controller 13, the overflow is eliminated, and the input operation is resumed beginning with the leading 128-byte data “5a, 5b” of the packet data subsequently detected.

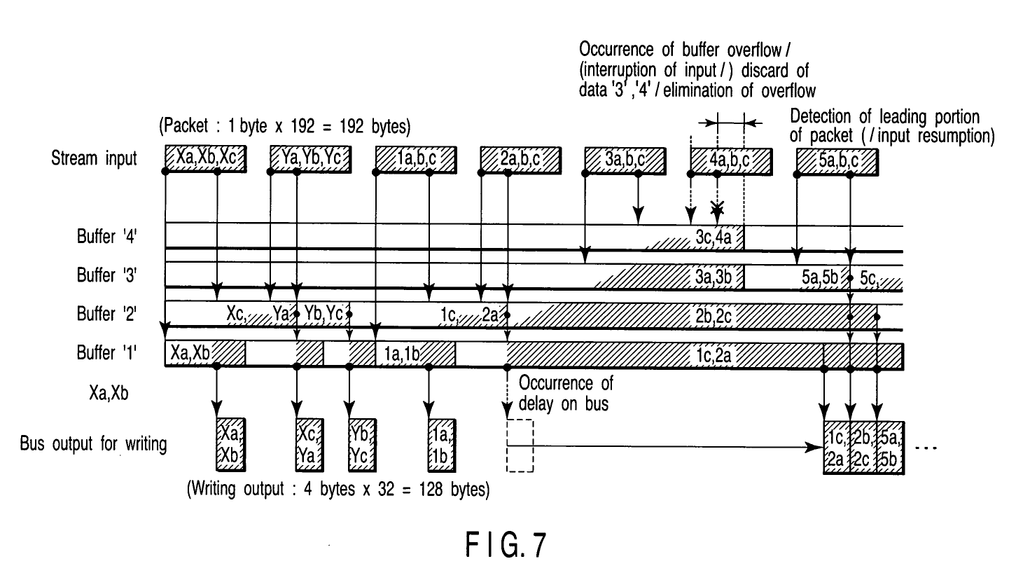

FIG. 7 is a timing chart illustrating an operation example corresponding to state 3 shown in FIG. 4C.

As shown in FIG. 7, since a delay has occurred during processing on the bus 3, buffers 1, 2, 3 and 4 are sequentially filled with data in this order. When overflow has occurred upon the input of the 65th byte of the 192-byte (fixed-length) data “4a, 4b, 4c”, the leading data of which is formed of the first data of the data input in units of 128 bytes, the data ranging from the third 120-byte data “3a, 3b” to the fourth (last) 128-byte data “3c, 4a” is discarded. As a result of this discarding process, a free space is produced to thereby eliminate the overflow, and the input operation is resumed beginning with the leading 128-byte data “5a, 5b” of the packet data subsequently detected.

As described above, in the I/O processing device according to the embodiment, which operates with an output transfer size of a fixed length different from that of the packets included in input stream data, defective packets, in which part of the data is lost, are prevented from occurring because of overflow in the transfer buffer. Namely, data in units of packets is secured, and it is not necessary for the host system to consider processing of defective packets when utilizing the output results of the I/O processing device.

In the above-described embodiment, data is buffered as data blocks each having a length shorter than the length of each packet, and is then transferred to the system memory 21. Alternatively, it may be modified such that data is buffered as data blocks each having a length longer than the length of each packet, and is then transferred to the system memory 21.

As described above in detail, in the invention, data transfer in units of packets can be secured even when overflow has occurred in the transfer buffer.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An input/output processing device comprising:
an input controller configured to sequentially input stream data including a plurality of successive packets each having a fixed length, the input controller inputting the stream data in units of data blocks each having a first length shorter than the fixed length;
an output controller configured to sequentially output, to a bus, data blocks each having a second length different from the fixed length;
a transfer buffer configured to accumulate data blocks input by the input controller while data blocks are output to the bus by the output controller; and
a transfer-buffer input controller configured to eliminate overflow, when the overflow occurs in the transfer buffer, by at least temporarily interrupting a data input operation of the input controller, and to cause the input controller to resume the data input operation with at least one of the packets lost.

2. The input/output processing device according to claim 1, wherein when overflow has occurred in a state in which part of data included in one of the packets is stored in the transfer buffer, the transfer-buffer input controller temporarily interrupts the data input operation of the input controller and performs a discarding process for discarding at least the part of the data contained in the transfer buffer to eliminate the overflow, and causes the input controller to resume the input operation beginning with a leading portion of a subsequent packet.

3. The input/output processing device according to claim 2, wherein the transfer-buffer input controller executes the discarding process in units of data blocks each having the second length.

4. The input/output processing device according to claim 1, wherein the second length is longer than the first length, and shorter than the fixed length.

5. The input/output processing device according to claim 1, wherein the fixed length is 192 bytes, the first length is 16 bytes, and the second length is 128 bytes.

6. A computer system comprising:
an input/output processing device connected between an input/output device and a bus; and
a host system connected to the input/output processing device via the bus,
the input/output processing device comprising:
an input controller configured to sequentially input stream data including a plurality of successive packets each having a fixed length, the input controller inputting the stream data in units of data blocks each having a first length shorter than the fixed length,
an output controller configured to sequentially output, to a bus, data blocks each having a second length different from the fixed length,
a transfer buffer configured to accumulate data blocks input by the input controller while data blocks are output to the bus by the output controller, and
a transfer-buffer input controller configured to eliminate overflow, when the overflow occurs in the transfer buffer, by at least temporarily interrupting a data input operation of the input controller, and to cause the input controller to resume the data input operation with at least one of the packets lost,
the host system receiving data from the input/output processing device via the bus, and performing processing in units of data blocks each having the fixed length.

7. The computer system according to claim 6, wherein when overflow has occurred in a state in which part of data included in one of the packets is stored in the transfer buffer, the transfer-buffer input controller temporarily interrupts the data input operation of the input controller and performs a discarding process for discarding at least the part of the data contained in the transfer buffer to eliminate the overflow, and causes the input controller to resume the input operation beginning with a leading portion of a subsequent packet.

8. The computer system according to claim 7, wherein the transfer-buffer input controller executes the discarding process in units of data blocks each having the second length.

9. The computer system according to claim 6, wherein the second length is longer than the first length, and shorter than the fixed length.

10. The computer system according to claim 6, wherein the fixed length is 192 bytes, the first length is 16 bytes, and the second length is 128 bytes.
